(19) United States
(12) Patent Application Publication
(10) Pub. No.: US 2025/0194448 A1
(43) Pub. Date: Jun. 19, 2025

(54) Closing System for Planters and Method of Use

(71) Applicant: Walter Carroll, Odessa, TX (US)

(72) Inventor: Walter Carroll, Odessa, TX (US)

(21) Appl. No.: 18/983,334

(22) Filed: Dec. 16, 2024

Related U.S. Application Data
(60) Provisional application No. 63/610,253, filed on Dec. 14, 2023.

(51) Int. Cl. A01B 21/08; A01B 63/28; A01C 5/06

(52) U.S. Cl. CPC A01B 21/086; A01B 63/28; A01C 5/064; A01C 5/066

(57) ABSTRACT

An row cleaner for cleaning and preparation of soil in a sequential manner as pulled in a direction of travel by a tractor. The row cleaner comprises at least a row cleaner assembly. The row cleaner assembly comprises one or more independent swing arm assemblies which are attached to and selectively rotate from a cleaning assembly frame within the row cleaner assembly. Each among the one or more independent swing arm assemblies comprises an extension arm having a proximate end and a distal end, and a cleaner assembly wheel. The proximate end rotates about a swing arm proximate axis. The cleaner assembly wheel comprise a first closing wheel assemblies and a second closing wheel assemblies. The cleaner assembly wheel rotates about a cleaning wheel axis. The cleaner assembly wheel is rotateably attached to the distal end. The cleaner assembly wheel is configured to remove debris and trash from the field.

### CROSS-REFERENCE TO RELATED APPLICATIONS

This application claims benefit to U.S. provisional application 63/610,253 filed 2023 Dec. 14.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

### Field of the Invention

The present invention relates generally to agricultural machinery, and more specifically to a system designed for cleaning rows in agricultural fields. It focuses on improvements in planter row cleaners that are used in conjunction with seeding and planting machinery.

### Description of the Related Art

In modern agriculture, the efficiency and effectiveness of planting processes are critical for optimizing crop yields. A significant aspect of this process involves preparing the soil and ensuring that seeds are planted in conditions conducive to optimal growth. Row cleaners are essential tools in this regard, used for clearing debris, trash, and other unwanted material from the rows into which seeds are to be planted.

Federal initiatives have recently emphasized the adoption of no-till farming as part of broader conservation efforts. Through the Inflation Reduction Act (IRA), the USDA's Natural Resources Conservation Service (NRCS) is directing nearly $23 billion over five years toward conservation practices, including no-till farming. NRCS Chief Terry Cosby described this as a “once-in-a-lifetime investment into conservation,” underscoring the importance of sustainable farming practices in modern agriculture.

Traditional row cleaning systems often face challenges related to adaptability and effectiveness in varied field conditions. Common issues include the inability to adequately adjust to different soil types, varying amounts of field debris, and differing moisture levels. Conventional row cleaners may also struggle with maintaining consistent contact with the ground, especially in uneven terrain, leading to incomplete cleaning and suboptimal planting conditions.

Additionally, many existing row cleaners are not designed to efficiently handle large amounts of residue or debris. This can lead to frequent clogging, increased maintenance needs, and interruptions in the planting process. Moreover, the rigid structures of some traditional row cleaners can cause excessive soil disturbance, leading to soil erosion and loss of valuable topsoil.

In one embodiment, the present disclosure overcomes these challenges by virtue of the unique camber of the cleaning wheels relative to the coulter wheel, which allows the system to catch debris and separate it immediately. This is particularly important because modern tractors often pull multiple row cleaners-sometimes 16 units at a time. If one of the cleaning wheels becomes clogged, it can cause the entire system to become plugged, leading to frame damage or unit failure. The novel camber arrangement prevents such clogging, ensuring smooth operation.

The current system is specifically designed to be non-plugging, a significant advancement over prior art. This is achieved through the unique arrangement of the cleaning wheels, which are dragged behind the frame, allowing the axis to turn and lift the cleaning wheels. Additionally, the camber of the extended arm causes the wheels to lift up and outward relative to the coulter wheel. As a result, debris is effectively released during operation, preventing the system from becoming plugged and ensuring consistent and reliable performance across a variety of field conditions.

### No-Till Farming and Related Advances

In recent years, there has been a significant push toward no-till farming, driven in part by federal initiatives encouraging farmers to adopt more sustainable practices. No-till farming reduces soil erosion, preserves moisture, and improves long-term soil health. The present invention aligns with these goals by offering an improved row cleaning system that efficiently prepares soil with minimal disruption, making it ideal for no-till farming operations.

The inventor has a distinguished history in no-till farming, having developed many components used in this field.

The present disclosure struck him one evening while sleeping. He awoke with this concept in his mind. He arose and began prototyping the system out of toothpicks. He was convinced that this system would solve many of the challenges of the prior art.

Existing row cleaning systems often rely on hydraulic air controllers to raise and lower both the cleaning wheels. However, these systems are complex, with air manifolds prone to cracking and cumbersome airlines leading to maintenance challenges. The present disclosure simplifies this approach, eliminating unnecessary components to provide a system that is less complex and more reliable.

The advancements presented below are particularly well-suited for modern agricultural machinery and practices, providing farmers with a robust, efficient, and scalable row cleaning solution.

No prior art is known to the Applicant.

### BRIEF SUMMARY OF THE INVENTION

An row cleaner for cleaning and preparation of soil in a sequential manner as pulled in a direction of travel by a tractor. Said row cleaner comprises at least a row cleaner assembly. Said row cleaner assembly comprises one or more independent swing arm assemblies which are attached to and selectively rotate from a cleaning assembly frame within said row cleaner assembly. Each among said one or more independent swing arm assemblies comprises an extension arm having a proximate end and a distal end, and a cleaner assembly wheel. Said proximate end rotates about a swing arm proximate axis. Said cleaner assembly wheel comprise a first closing wheel assemblies and a second closing wheel assemblies. Said cleaner assembly wheel rotates about a cleaning wheel axis. Said cleaner assembly wheel is rotateably attached to said distal end. Said cleaner assembly wheel is configured to remove debris and trash from the field. Said row cleaner assembly further comprises a coulter wheel. Said one or more independent swing arm assemblies extend backward away from said direction of travel. Said extension arm is mounted with said proximate end closer to a front portion of said row cleaner and said distal end toward the back. Said row cleaner allows said one or more independent swing arm assemblies to roll over debris in a field and rotate upward. Said cleaner assembly wheel extend backward along said one or more independent swing arm assemblies away from said direction of travel. Said extension arm is mounted with said proximate end closer to a front portion of said row cleaner and said distal end toward the back. Said one or more independent swing arm assemblies comprises a first swing arm assembly on a first side of said row cleaner and a second swing arm assembly on a second side of said row cleaner. Said row cleaner assembly is configured to selectively transition between an engaged configuration and a disengaged configuration by rotating around said swing arm proximate axis.

An row cleaner for cleaning and preparation of soil in a sequential manner as pulled in the direction of travel by the tractor. Said row cleaner comprises three main assemblies: the row cleaner assembly, a middle assembly, and a closing system. Said row cleaner assembly comprises one or more independent swing arm assemblies which is attached to and selectively rotate from the cleaning assembly frame within said row cleaner assembly. Each among said one or more independent swing arm assemblies comprises the extension arm having the proximate end and the distal end, and the cleaner assembly wheel. Said proximate end is designed to rotate along an second arm assembly and is connected to said cleaning assembly frame. Said distal end of each among said one or more independent swing arm assemblies comprises said cleaner assembly wheel configured to remove debris and trash from the field. Said cleaner assembly wheel is configured to rotate about the cleaning wheel axis at said distal end. Said row cleaner assembly further comprises the coulter wheel configured to cut into the ground as is customary in agricultural practice. Said closing system comprises cleaner assembly wheel. Each among said cleaner assembly wheel are configured with said extension arm having said proximate end and said distal end, and an a closing wheel. Said one or more independent swing arm assemblies and said cleaner assembly wheel extend backward away from said direction of travel. Said extension arm is mounted with said proximate end closer to a front portion of said row cleaner and said distal end toward the back. Accordingly, said row cleaner is configured to allow said one or more independent swing arm assemblies and said cleaner assembly wheel to roll over debris and trash in a field and rotate upward.

An row cleaner for cleaning and preparation of soil in a sequential manner as pulled in the direction of travel by the tractor. Said row cleaner comprises three main assemblies: the row cleaner assembly, the middle assembly, and the closing system. Said row cleaner assembly comprises one or more independent swing arm assemblies which is attached to and selectively rotate from the cleaning assembly frame within said row cleaner assembly. Each among said one or more independent swing arm assemblies comprises the extension arm having the proximate end and the distal end, and the cleaner assembly wheel. Said proximate end is designed to rotate along the second arm assembly and is connected to said cleaning assembly frame. Said distal end of each among said one or more independent swing arm assemblies comprises said cleaner assembly wheel configured to remove debris and trash from the field. Said cleaner assembly wheel is configured to rotate about the cleaning wheel axis at said distal end. Said row cleaner assembly further comprises the coulter wheel configured to cut into the ground as is customary in agricultural practice. Said closing system comprises cleaner assembly wheel. Each among said cleaner assembly wheel are configured with said extension arm having said proximate end and said distal end, and the a closing wheel. Said one or more independent swing arm assemblies and said cleaner assembly wheel extend backward away from said direction of travel. Said extension arm is mounted with said proximate end closer to a front portion of said row cleaner and said distal end toward the back. Accordingly, said row cleaner is configured to allow said one or more independent swing arm assemblies and said cleaner assembly wheel to roll over debris and trash in a field and rotate upward. Said cleaner assembly wheel comprise a first closing wheel assemblies and a second closing wheel assemblies. Said one or more independent swing arm assemblies and said cleaner assembly wheel extend backward away from said direction of travel. Said extension arm is mounted with said proximate end closer to a front portion of said row cleaner and said distal end toward the back. Accordingly, said row cleaner is configured to allow said one or more independent swing arm assemblies and said cleaner assembly wheel to roll over debris and trash in a field and rotate upward. Said one or more independent swing arm assemblies comprises the first swing arm assembly on the first side of said row cleaner and the second swing arm assembly on the second side of said row cleaner. Said row cleaner assembly and said closing system are configured to selectively transition between the engaged configuration and the disengaged configuration, and wherein, each can transition between said engaged configuration and said disengaged configuration by rotating around said second arm assembly. Said second arm assembly is cambered to direct said one or more independent swing arm assemblies outward from said first side and said second side and, further cambered, to direct a bottom portion of said cleaner assembly wheel inward toward said coulter wheel. As said one or more independent swing arm assemblies transition to said disengaged configuration, they will naturally pull debris away from said coulter wheel and not lock up.

### BRIEF DESCRIPTION OF THE SEVERAL VIEWS OF THE DRAWING

FIGS. 1A and 1B illustrate a plurality of a row cleaner 100 attached to a tractor 102. FIG. 1A provides a side view showing the arrangement and connection of a plurality of said row cleaner 100 to said tractor 102. FIG. 1B offers a perspective overview of said row cleaner 100, highlighting its individual components and their spatial relationships.

FIG. 2A illustrates an elevated top view of said row cleaner 100.

FIG. 2B depicts an elevated side view of said row cleaner 100, showing said row cleaner assembly 104, said middle assembly 106, and said closing system 108 in profile.

FIGS. 3A and 3B illustrate two elevated side views of said row cleaner 100 with said row cleaner assembly 104 and said closing system 108 in various configurations.

FIG. 4 illustrates a perspective overview of said row cleaner assembly 104.

FIG. 5 illustrates an elevated side view of row cleaner 100.

FIG. 6 illustrates a perspective overview of row cleaner assembly 104.

FIGS. 7-8 illustrate an elevated side view of said row cleaner assembly 104 in said engaged configuration 300 and said disengaged configuration 302, respectively.

FIGS. 9-10 illustrate an elevated front view of said row cleaner assembly 104 in said engaged configuration 300 and said disengaged configuration 302, respectively.

FIG. 11 illustrates an elevated top view of said row cleaner assembly 104 in said disengaged configuration 302.

FIG. 12 illustrates a perspective overview of cleaning assembly frame 202 with said tension adjustment handle 414, said center mount plate 416, and sliding block assembly 412.

FIG. 13 illustrates a perspective overview of cleaning assembly frame 202.

FIGS. 14A, 14B and 14C illustrate a perspective overview of said center mount plate 416, an elevated side view of sliding block assembly 412 and an exploded perspective overview of sliding block assembly 412, respectively.

FIG. 15 illustrates an exploded view of first swing arm assembly 200a with a swing arm bushing 1500, a swing arm bearing 1502, and a retaining ring 1504.

FIG. 16 illustrates an elevated top view of said first swing arm assembly 200a.

FIGS. 17A, 17B, 17C, 17D and 17E illustrate several elevated views of said first swing arm assembly 200a.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

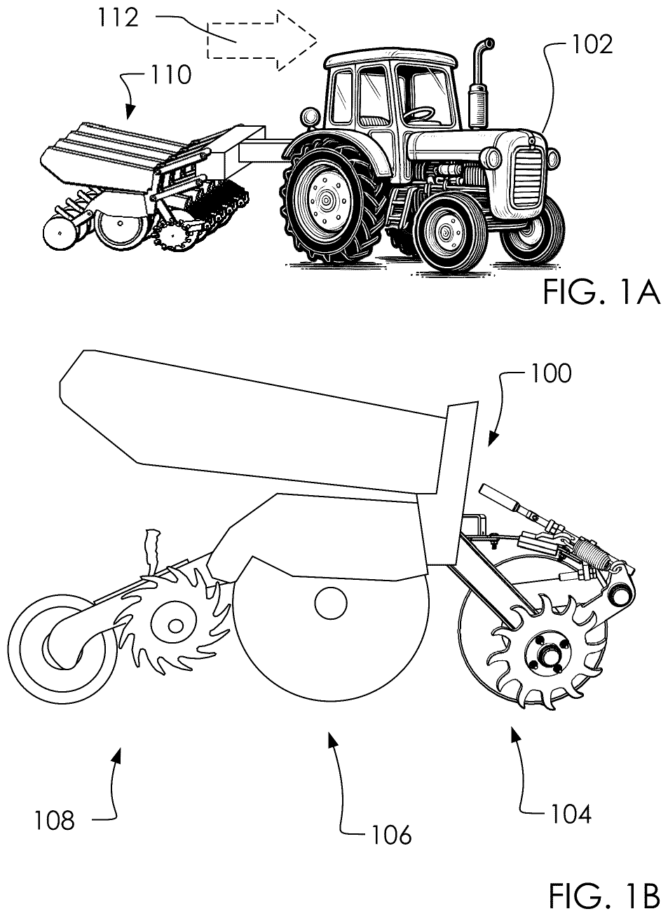

FIGS. 1A and 1B illustrate a plurality of a row cleaner 100 attached to a tractor 102. FIG. 1A provides a side view showing the arrangement and connection of a plurality of said row cleaner 100 to said tractor 102. FIG. 1B offers a perspective overview of said row cleaner 100, highlighting its individual components and their spatial relationships.

In one embodiment, said row cleaner 100 can comprise a portion of a planter unit 110. As is known, a plurality of said row cleaner 100 can be arranged in parallel, referred to as said planter unit 110; and pulled by tractor 102 in direction of travel 112.

Said row cleaner 100 can comprise three main assemblies: a row cleaner assembly 104, a middle assembly 106, and a closing system 108. The configuration of these assemblies is designed to optimize the cleaning, tilling, planting and closing of soil in a sequential manner as said row cleaner 100 is pulled in the direction of travel 112 by said tractor 102.

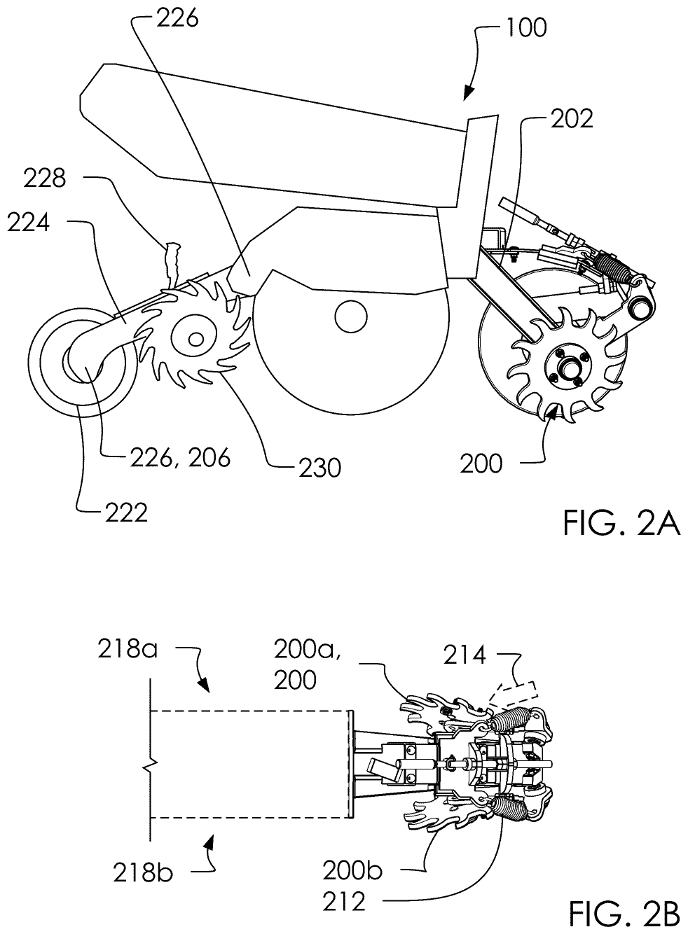

FIG. 2A illustrates an elevated top view of said row cleaner 100.

FIG. 2B depicts an elevated side view of said row cleaner 100, showing said row cleaner assembly 104, said middle assembly 106, and said closing system 108 in profile.

In one embodiment, said row cleaner assembly 104 can comprise one or more independent swing arm assemblies 200 which can be attached to and selectively rotate from a cleaning assembly frame 202 within said row cleaner assembly 104.

In one embodiment, each among said one or more independent swing arm assemblies 200 can further comprise a planter spring 212.

Said planter spring 212 can provide an elastic force 214 acting on one or more independent swing arm assemblies 200.

In one embodiment, said closing system 108 can comprise one or more cleaner wheels 230 being adjustable in height relative to a closing system frame 224, and a closing wheel 222. In one embodiment, closing system frame 224 can attach to a portion of middle assembly 106 and rotate on a closing system rotating axis 226. In one embodiment, one or more cleaner wheels 230 can be adjusted using an adjustment handle 228.

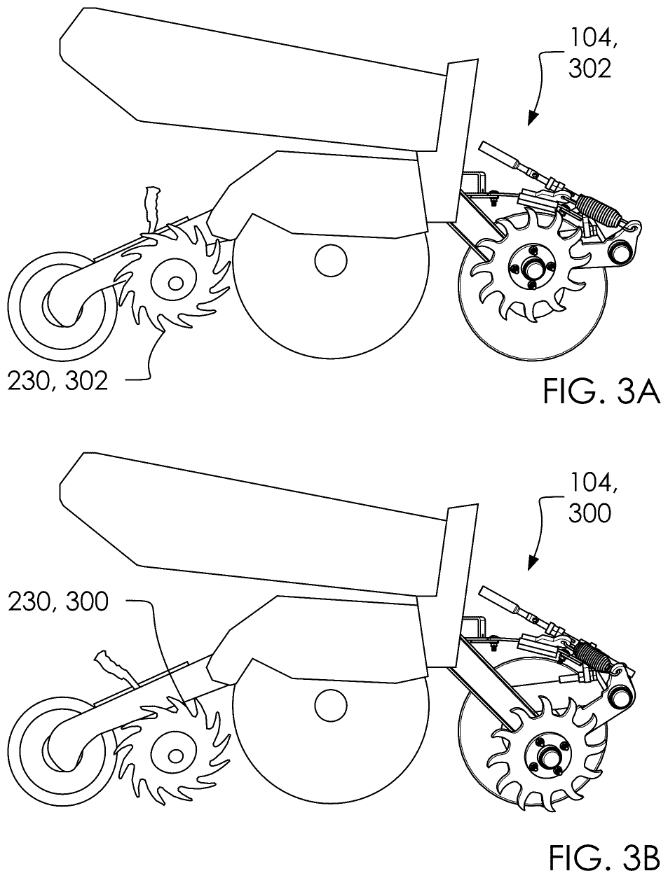

FIGS. 3A and 3B illustrate two elevated side views of said row cleaner 100 with said row cleaner assembly 104 and said closing system 108 in various configurations.

In one embodiment, said row cleaner assembly 104 and said closing system 108 can transition between an engaged configuration 300 and a disengaged configuration 302. Wherein, each can transition between said engaged configuration 300 and said disengaged configuration 302 by rotating around said second arm assembly 208, as illustrated.

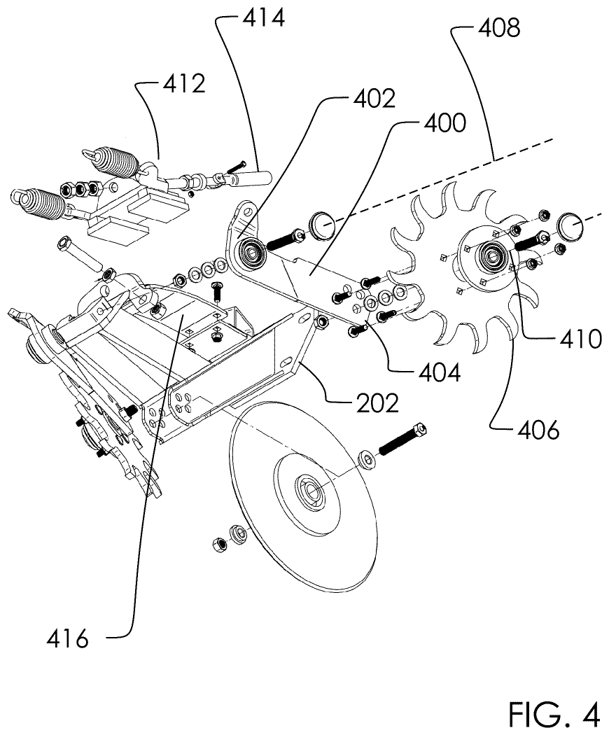

FIG. 4 illustrates a perspective overview of said row cleaner assembly 104.

Each among said one or more independent swing arm assemblies 200 can comprise an extension arm 400 having a proximate end 402 and a distal end 404, and a cleaner assembly wheel 406. Wherein, said proximate end 402 can be designed to rotate along a swing arm proximate axis 408 and can be connected to said cleaning assembly frame 202. Said distal end 404 of each among said one or more independent swing arm assemblies 200 can comprise said cleaner assembly wheel 406, configured to remove debris and trash from the field. Said cleaner assembly wheel 406 can be configured to rotate about a cleaning wheel axis 410 at said distal end 404.

In one embodiment, row cleaner assembly 104 can comprise further comprise a sliding block assembly 412, a tension adjustment handle 414, and a center mount plate 416.

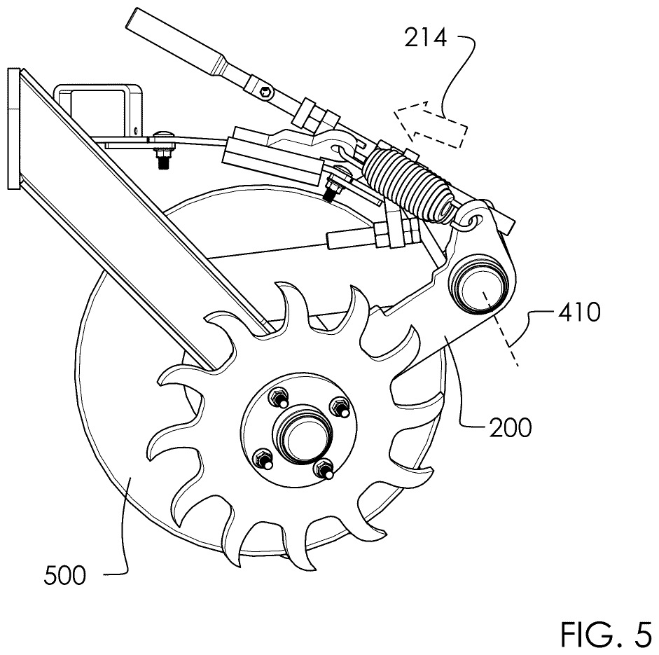

FIG. 5 illustrates an elevated side view of row cleaner 100.

In one embodiment, planter spring 212 can be connected to said proximate end 402 at one end and a portion of said cleaning assembly frame 202 at another end. Said planter spring 212 can provide the elastic force 214 around said second arm assembly 208, ensuring that said one or more independent swing arm assemblies 200 are pressed into the ground. Importantly, said elastic force 214 allows the entire assembly to rise when encountering debris along its path, enhancing adaptability and efficiency in varying field conditions.

In one embodiment, said planter spring 212 can be arranged above said one or more independent swing arm assemblies 200 and configured for pulling at a point above said cleaning wheel axis 410.

Additionally, within said row cleaner assembly 104, a coulter wheel 500 can be integrated, designed to cut into the ground as is customary in agricultural practice.

Said one or more independent swing arm assemblies 200 can comprise a first swing arm assembly 200a on a first side 218a of said row cleaner 100 and a second swing arm assembly 200b on a second side 218b of said row cleaner 100. This arrangement can facilitate balanced and effective cleaning across the width of said row cleaner 100.

In one embodiment, said one or more independent swing arm assemblies 200 and said cleaner assembly wheel 406 can extend backward away from said direction of travel 112. For example, said extension arm 400 can be mounted with said proximate end 402 closer to a front portion of said row cleaner 100 and said distal end 404 toward the back. Accordingly, said row cleaner 100 can be configured to allow said one or more independent swing arm assemblies 200 and said cleaner assembly wheel 406 to roll over debris and trash in a field and rotate upward. Whereas the prior art mounts arms and wheels in a forward orientation which can cause clogging and digging into the earth when rolling over a field.

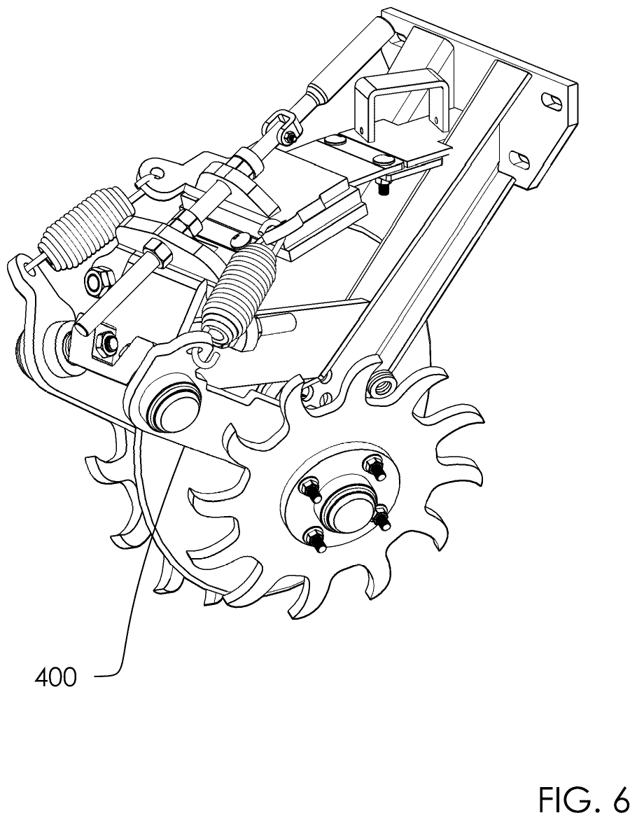

FIG. 6 illustrates a perspective overview of row cleaner assembly 104.

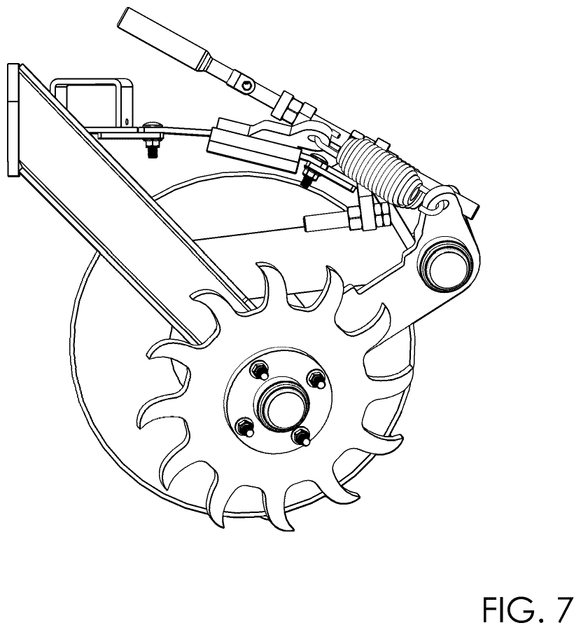

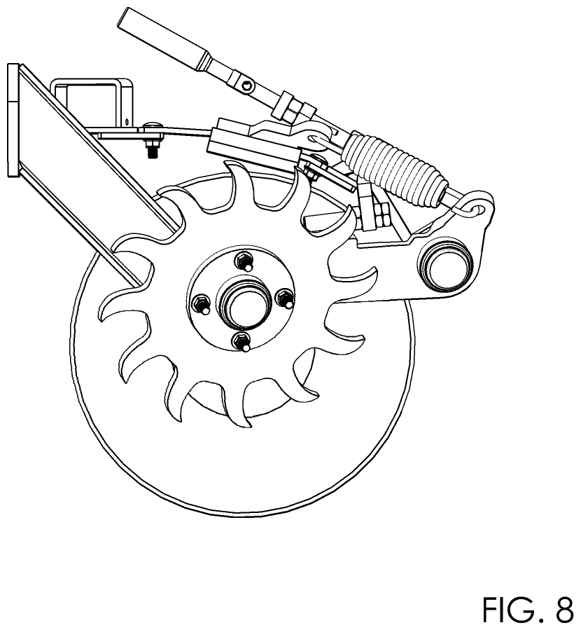

FIGS. 7-8 illustrate an elevated side view of said row cleaner assembly 104 in said engaged configuration 300 and said disengaged configuration 302, respectively.

It is noted that in the prior art, a coulter wheel 500 and said cleaner assembly wheel 406 rotate relative to one another about an axis. In this configuration, there is no allowance for a camber of the axes as illustrated herein. Accordingly, there is no means for ridding said cleaner assembly wheel 406 of debris when rolling over a ground surface.

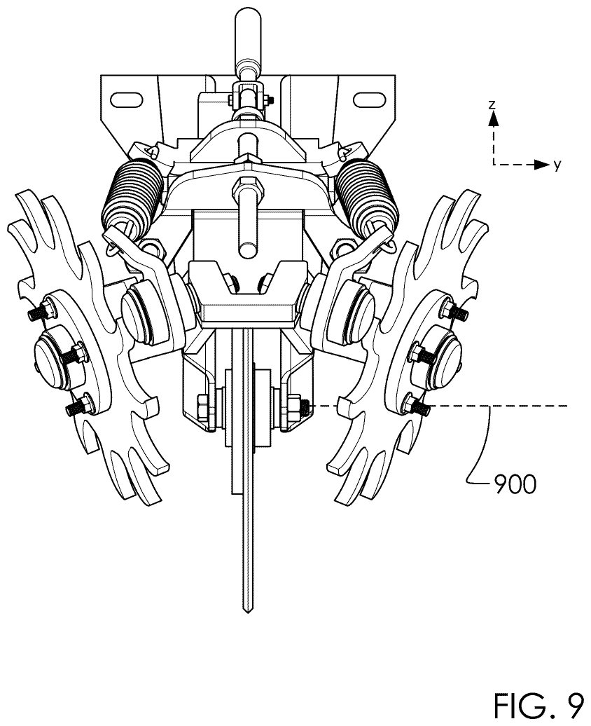

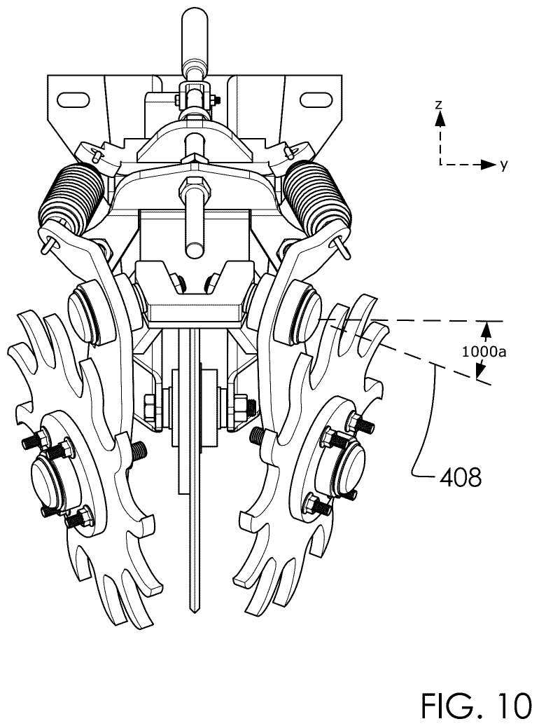

FIGS. 9-10 illustrate an elevated front view of said row cleaner assembly 104 in said engaged configuration 300 and said disengaged configuration 302, respectively.

In one embodiment, said coulter wheel 500 can comprise a coulter axis 900 comprising a sideways tangent relative to direction of travel 112. As illustrated, coulter axis 900 can be substantially parallel with the y-axis.

For discussion purposes, we will refer to direction of travel 112 as the x-axis. Accordingly, the elevated front view of row cleaner assembly 104 represents the y-axis and z-axis.

In one embodiment, swing arm proximate axis 408 can be arranged at an angular offset 1000 relative to said direction of travel 112. In one embodiment, said angular offset 1000 can comprise a y-axis offset 1000a, a z-axis offset 1000b (not illustrated) and an x-axis offset 1000c (illustrated below). In one embodiment, y-axis offset 1000a can comprise about 20 degrees, and z-axis offset 1000b can comprise about 23 degrees.

Cumulatively, angular offset 1000 can comprise the sum of the vectors represented by y-axis offset 1000a, z-axis offset 1000b, and x-axis offset 1000c.

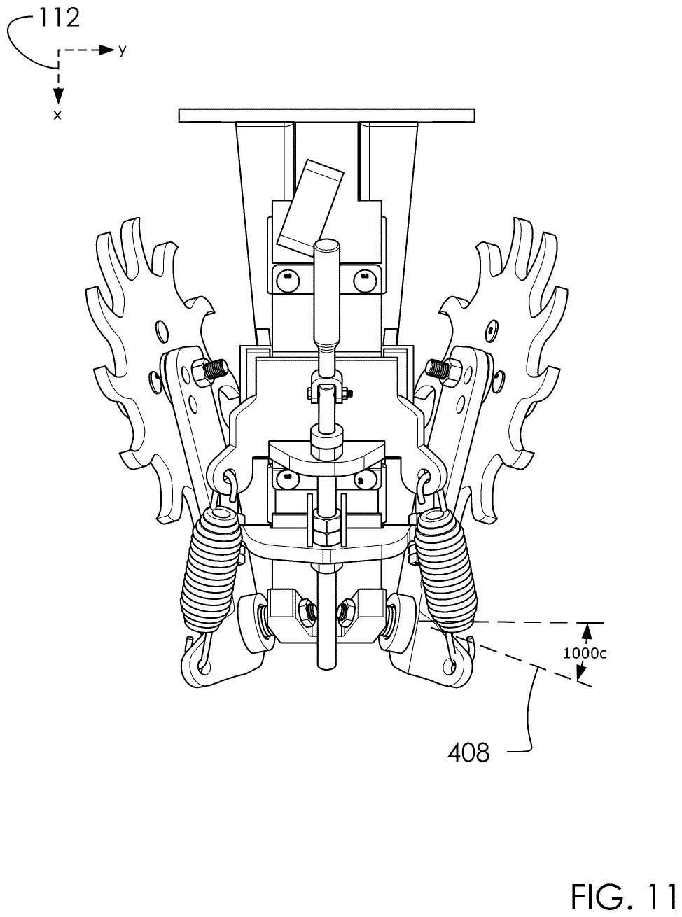

FIG. 11 illustrates an elevated top view of said row cleaner assembly 104 in said disengaged configuration 302.

In one embodiment, said x-axis offset 1000c can comprise about 20 degrees.

In one embodiment, said angular offset 1000 can cause said swing arm proximate axis 408 to point generally forward and down relative to said coulter axis 900.

Accordingly, each among said swing arm proximate axis 408 can be cambered along angular offset 1000 to direct said one or more independent swing arm assemblies 200 outward from the first side 218a and the second side 218b. Accordingly, as said one or more independent swing arm assemblies 200 transition to said disengaged configuration 302, they will naturally pull debris away from said coulter wheel 500 and prevent plugging up one or more independent swing arm assemblies 200 and coulter wheel 500.

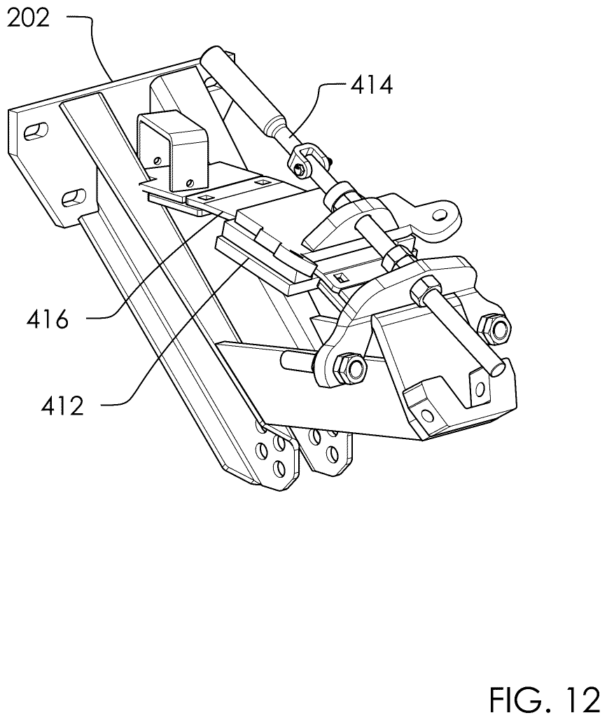

FIG. 12 illustrates a perspective overview of cleaning assembly frame 202 with said tension adjustment handle 414, said center mount plate 416, and sliding block assembly 412.

In one embodiment, tension adjustment handle 414 can be configured to selectively apply and release tension on row cleaner assembly 104 to customize the cleaning intensity and characteristics of row cleaner assembly 104.

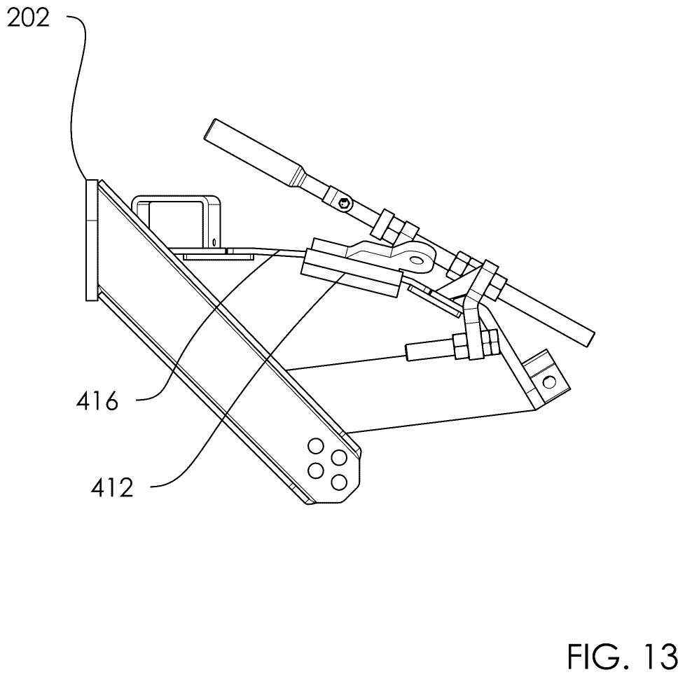

FIG. 13 illustrates a perspective overview of cleaning assembly frame 202.

It is noted that here, the elements of cleaning assembly frame 202 are shown as individual parts which must be assembled, such as by welding, in one preferred embodiment many of the parts of cleaning assembly frame 202 will be casted. The benefits of this casting process will result in a more resilient part with lower manufacturing requirements.

In one embodiment, sliding block assembly 412 is configured to slide among center mount plate 416 to alleviate stress on cleaning assembly frame 202.

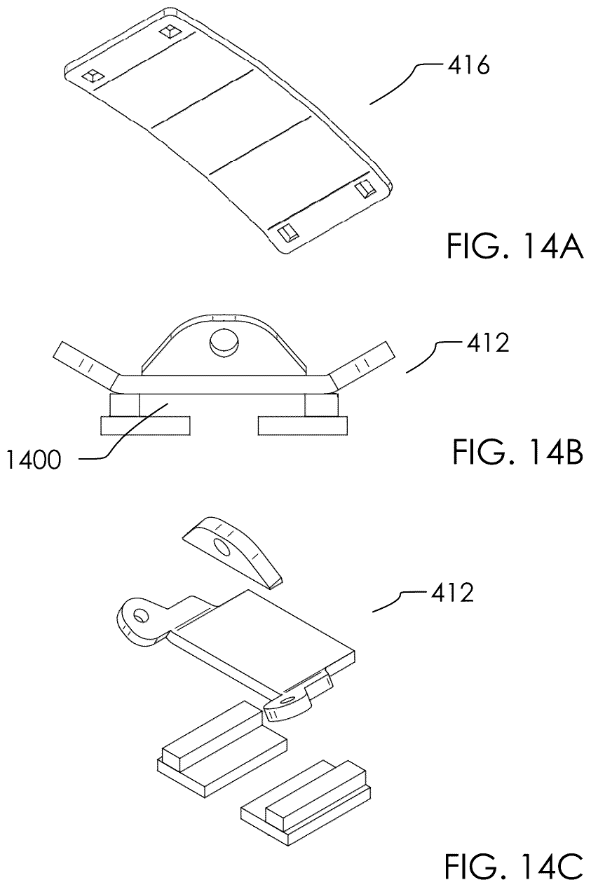

FIGS. 14A, 14B and 14C illustrate a perspective overview of said center mount plate 416, an elevated side view of sliding block assembly 412 and an exploded perspective overview of sliding block assembly 412, respectively.

In one embodiment, sliding block assembly 412 can comprise a plate-slot 1400 and two spring apertures 1402. Said plate-slot 1400 can be configured to slide around an edge portion of said center mount plate 416. Said two spring apertures 1402 can be configured to receive a portion of said planter spring 212.

In one embodiment, by allowing sliding block assembly 412 to slide relative to center mount plate 416, said row cleaner assembly 104 can be configured to protect said cleaning assembly frame 202 from unnecessary tension and breaking.

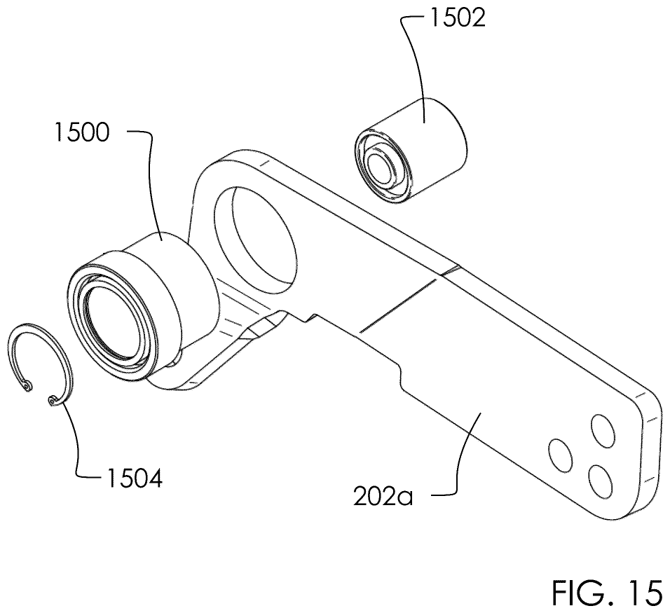

FIG. 15 illustrates an exploded view of first swing arm assembly 200a with a swing arm bushing 1500, a swing arm bearing 1502, and a retaining ring 1504.

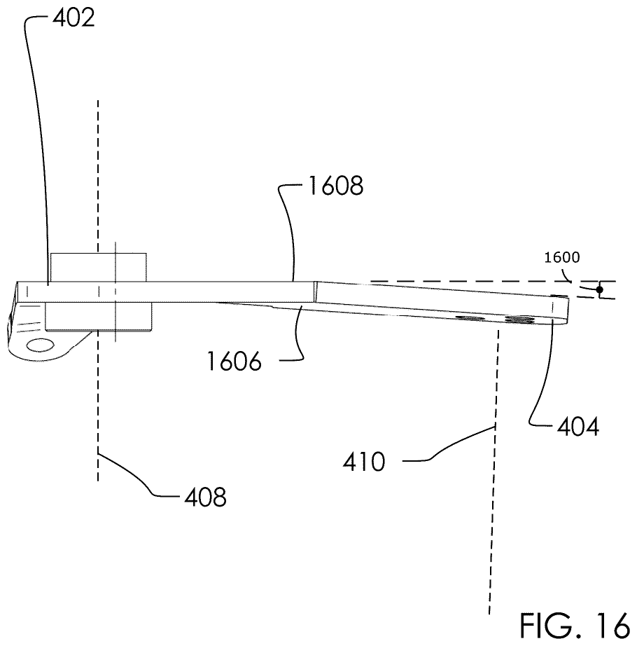

FIG. 16 illustrates an elevated top view of said first swing arm assembly 200a.

Said one or more independent swing arm assemblies 200 can comprise said proximate end 402, said distal end 404, said swing arm proximate axis 408, said cleaning wheel axis 410, an exterior face 1606 and an interior face 1608.

In one embodiment, said one or more independent swing arm assemblies 200 can comprise a distal end camber 1600 of exterior face 1606 and therefore of cleaning wheel axis 410.

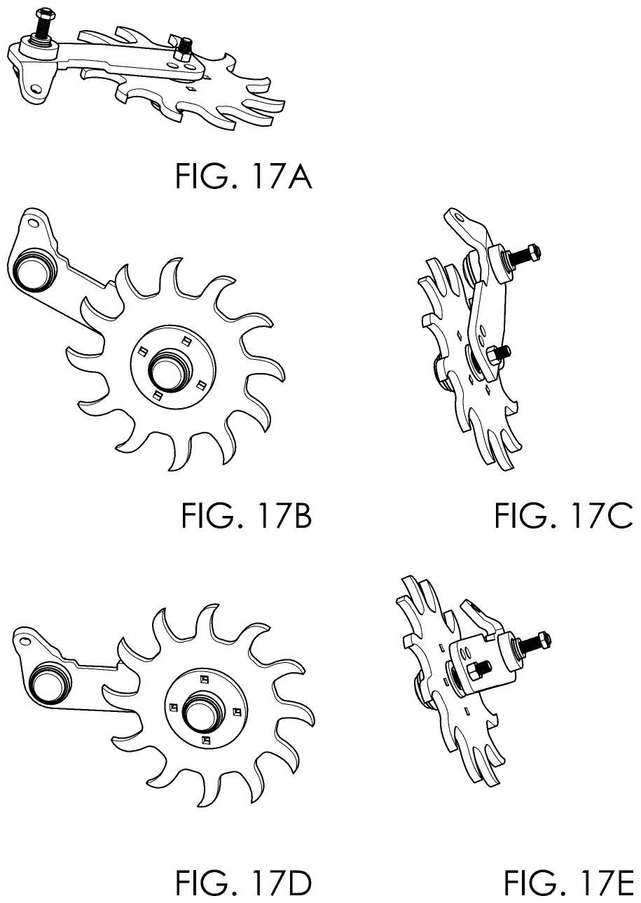

FIGS. 17A, 17B, 17C, 17D and 17E illustrate several elevated views of said first swing arm assembly 200a.

### PARTS LIST

row cleaner 100,
tractor 102,
row cleaner assembly 104,
middle assembly 106,
closing system 108,
planter unit 110,
direction of travel 112,
first swing arm assembly 200a,
second swing arm assembly 200b,
one or more independent swing arm assemblies 200,
cleaning assembly frame 202,
second arm assembly 208,
planter spring 212,
elastic force 214,
first side 218a,
second side 218b,
a closing wheel 222,
closing system frame 224,
closing system rotating axis 226,
adjustment handle 228,
one or more cleaner wheels 230,
engaged configuration 300,
disengaged configuration 302,
extension arm 400,
proximate end 402,
distal end 404,
cleaner assembly wheel 406,
swing arm proximate axis 408,
cleaning wheel axis 410,
sliding block assembly 412,
tension adjustment handle 414,
center mount plate 416,
coulter wheel 500,
coulter axis 900,
z-axis offset 1000b,
x-axis offset 1000c,
angular offset 1000,
y-axis offset 1000a,
plate-slot 1400,
two spring apertures 1402,
swing arm bushing 1500,
swing arm bearing 1502,
retaining ring 1504,
distal end camber 1600,
exterior face 1606, and
interior face 1608.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An row cleaner for cleaning and preparation of soil in a sequential manner as pulled in a direction of travel by a tractor, wherein:
said row cleaner comprises at least a row cleaner assembly;
said row cleaner assembly comprises one or more independent swing arm assemblies which are attached to and selectively rotate from a cleaning assembly frame within said row cleaner assembly;
each among said one or more independent swing arm assemblies comprises an extension arm having a proximate end and a distal end, and a cleaner assembly wheel;
said proximate end rotates about a swing arm proximate axis;
said cleaner assembly wheel comprise a first closing wheel assemblies and a second closing wheel assemblies;
said cleaner assembly wheel rotates about a cleaning wheel axis;
said cleaner assembly wheel is rotateably attached to said distal end;
said cleaner assembly wheel is configured to remove debris and trash from the field;
said row cleaner assembly further comprises a coulter wheel;
said one or more independent swing arm assemblies extend backward away from said direction of travel;
said extension arm is mounted with said proximate end closer to a front portion of said row cleaner and said distal end toward the back;
said row cleaner allows said one or more independent swing arm assemblies to roll over debris in a field and rotate upward;
said cleaner assembly wheel extend backward along said one or more independent swing arm assemblies away from said direction of travel;
said extension arm is mounted with said proximate end closer to a front portion of said row cleaner and said distal end toward the back;
said one or more independent swing arm assemblies comprises a first swing arm assembly on a first side of said row cleaner and a second swing arm assembly on a second side of said row cleaner;
said row cleaner assembly is configured to selectively transition between an engaged configuration and a disengaged configuration by rotating around said swing arm proximate axis.

2. The row cleaner of claim 1, wherein:
said second arm assembly is cambered to direct said one or more independent swing arm assemblies outward from said first side and said second side and
as said one or more independent swing arm assemblies transition to said disengaged configuration, they will naturally pull debris away from said coulter wheel and not lock up.

3. The row cleaner of claim 1, wherein:
each among said one or more independent swing arm assemblies can further comprise a planter spring connected to said proximate end at one end and a portion of said cleaning assembly frame at another end;
said planter spring provides an elastic force around said second arm assembly, ensuring that the cleaning wheel is pressed into the ground;
said elastic force allows the entire assembly to rise when encountering debris along its path, enhancing adaptability and efficiency in varying field conditions; and
said planter spring is arranged above said one or more independent swing arm assemblies and configured for pulling at a point above said swing arm proximate axis.

4. An row cleaner for cleaning and preparation of soil in a sequential manner as pulled in a direction of travel by a tractor, wherein:
said row cleaner comprises three main assemblies: a row cleaner assembly, a middle assembly, and a closing system;
said row cleaner assembly comprises one or more independent swing arm assemblies which is attached to and selectively rotate from a cleaning assembly frame within said row cleaner assembly;
each among said one or more independent swing arm assemblies comprises an extension arm having a proximate end and a distal end, and a cleaner assembly wheel;
said proximate end is designed to rotate along an second arm assembly and is connected to said cleaning assembly frame;
said distal end of each among said one or more independent swing arm assemblies comprises said cleaner assembly wheel configured to remove debris and trash from the field;
said cleaner assembly wheel is configured to rotate about a cleaning wheel axis at said distal end;
said row cleaner assembly further comprises a coulter wheel configured to cut into the ground as is customary in agricultural practice;
said closing system comprises cleaner assembly wheel;
each among said cleaner assembly wheel are configured with said extension arm having said proximate end and said distal end, and an a closing wheel;
said one or more independent swing arm assemblies and said cleaner assembly wheel extend backward away from said direction of travel;
said extension arm is mounted with said proximate end closer to a front portion of said row cleaner and said distal end toward the back; and
accordingly, said row cleaner is configured to allow said one or more independent swing arm assemblies and said cleaner assembly wheel to roll over debris and trash in a field and rotate upward.

5. The row cleaner of claim 4, wherein:
said cleaner assembly wheel comprise a first closing wheel assemblies and a second closing wheel assemblies.

6. The row cleaner of claim 4, wherein:
said one or more independent swing arm assemblies and said cleaner assembly wheel extend backward away from said direction of travel;
said extension arm is mounted with said proximate end closer to a front portion of said row cleaner and said distal end toward the back; and
accordingly, said row cleaner is configured to allow said one or more independent swing arm assemblies and said cleaner assembly wheel to roll over debris and trash in a field and rotate upward.

7. The row cleaner of claim 4, wherein:
said one or more independent swing arm assemblies comprises a first swing arm assembly on a first side of said row cleaner and a second swing arm assembly on a second side of said row cleaner.

8. The row cleaner of claim 4, wherein:
each among said one or more independent swing arm assemblies can further comprise a planter spring connected to said proximate end at one end and a portion of said cleaning assembly frame at another end;
said planter spring can provide an elastic force around said second arm assembly, ensuring that the cleaning wheel is pressed into the ground;
said elastic force allows the entire assembly to rise when encountering debris along its path, enhancing adaptability and efficiency in varying field conditions; and
said planter spring is arranged above said one or more independent swing arm assemblies and configured for pulling at a point above said second arm assembly.

9. The row cleaner of claim 4, wherein:
said row cleaner assembly and said closing system are configured to selectively transition between an engaged configuration and a disengaged configuration; and
wherein, each can transition between said engaged configuration and said disengaged configuration by rotating around said second arm assembly.

10. The row cleaner of claim 4, wherein:
said second arm assembly is cambered so as to direct said one or more independent swing arm assemblies outward from said first side and said second side and, further cambered, to direct a bottom portion of said cleaner assembly wheel inward toward said coulter wheel; and
as said one or more independent swing arm assemblies transition to said disengaged configuration, they will naturally pull debris away from said coulter wheel and not lock up.

11. An row cleaner for cleaning and preparation of soil in a sequential manner as pulled in a direction of travel by a tractor, wherein:
said row cleaner comprises three main assemblies: a row cleaner assembly, a middle assembly, and a closing system;
said row cleaner assembly comprises one or more independent swing arm assemblies which is attached to and selectively rotate from a cleaning assembly frame within said row cleaner assembly;
each among said one or more independent swing arm assemblies comprises an extension arm having a proximate end and a distal end, and a cleaner assembly wheel;
said proximate end is designed to rotate along an second arm assembly and is connected to said cleaning assembly frame;
said distal end of each among said one or more independent swing arm assemblies comprises said cleaner assembly wheel configured to remove debris and trash from the field;
said cleaner assembly wheel is configured to rotate about a cleaning wheel axis at said distal end;
said row cleaner assembly further comprises a coulter wheel configured to cut into the ground as is customary in agricultural practice;
said closing system comprises cleaner assembly wheel;
each among said cleaner assembly wheel are configured with said extension arm having said proximate end and said distal end, and an a closing wheel;
said one or more independent swing arm assemblies and said cleaner assembly wheel extend backward away from said direction of travel;
said extension arm is mounted with said proximate end closer to a front portion of said row cleaner and said distal end toward the back;
accordingly, said row cleaner is configured to allow said one or more independent swing arm assemblies and said cleaner assembly wheel to roll over debris and trash in a field and rotate upward;
said cleaner assembly wheel comprise a first closing wheel assemblies and a second closing wheel assemblies;
said one or more independent swing arm assemblies and said cleaner assembly wheel extend backward away from said direction of travel;
said extension arm is mounted with said proximate end closer to a front portion of said row cleaner and said distal end toward the back;
accordingly, said row cleaner is configured to allow said one or more independent swing arm assemblies and said cleaner assembly wheel to roll over debris and trash in a field and rotate upward;
said one or more independent swing arm assemblies comprises a first swing arm assembly on a first side of said row cleaner and a second swing arm assembly on a second side of said row cleaner;
said row cleaner assembly and said closing system are configured to selectively transition between an engaged configuration and a disengaged configuration, and wherein, each can transition between said engaged configuration and said disengaged configuration by rotating around said second arm assembly;
said second arm assembly is cambered to direct said one or more independent swing arm assemblies outward from said first side and said second side and, further cambered, to direct a bottom portion of said cleaner assembly wheel inward toward said coulter wheel; and
as said one or more independent swing arm assemblies transition to said disengaged configuration, they will naturally pull debris away from said coulter wheel and not lock up.
